(19) United States
(12) Patent Application Publication
(10) Pub. No.: US 2013/0209181 A1
(43) Pub. Date: Aug. 15, 2013

(54) Self-emptying vacuum apparatus for use by gold prospectors

(71) Applicant: Gregory A. Van Arsdale, Greeley, CO (US)

(72) Inventor: Gregory A. Van Arsdale, Greeley, CO (US)

(21) Appl. No.: 13/385,363

(22) Filed: Feb. 15, 2012

(51) Int. Cl. B65G 53/40

(52) U.S. Cl. 406/168

(57) ABSTRACT

A self-emptying vacuum apparatus for use by gold prospectors includes a collection chamber, a vacuum source, a suction hose connected to the collection chamber for vacuum-collecting material from a work surface, and a flapper assembly for discharging accumulated material. During operation, the vacuum source creates a vacuum within the collection chamber sufficient to close a flapper of the flapper assembly, thereby creating a vacuum seal that causes the flow of air through the suction hose, into the collection chamber, and out of the vacuum source, allowing vacuum-collected material to drop into the collection chamber. When the weight of material accumulated within the collection chamber is sufficient to overcome the vacuum force maintaining the flapper closed, the flapper opens to discharge the accumulated material. As soon as each accumulated load of vacuum-collected material is discharged, the flapper is again drawn closed, and the collection and discharge cycle is repeated.

### BACKGROUND AND SUMMARY OF THE INVENTION

This invention relates generally to precious metals prospecting and, more particularly, to a self-emptying vacuum device for use by prospectors for collecting dirt material that contains gold particles.

Throughout history, prospectors seeking gold, silver, and gemstones have generally labored with pick, shovel, and gold pan to sift through large quantities of unwanted dirt and gravel material to uncover the sought after precious metals that can take the form of miniscule flakes. A shovel load of dirt and gravel is dumped into the gold pan, which is then typically submerged in a river or stream and agitated or panned to allow the heavier materials to sink to the bottom of the pan. The precious metal material, being heavier than the dirt and gravel, is recovered as the material finally remaining at the bottom of the pan. Over time, the gold sinks deep into cracks and crevices in bedrock or other dense material, and many rich deposits have been left high and dry as the result of changes in the position of river and stream channels during the past 100 years or more. The sluice box was developed to better work these rich deposits that now lie outside river and stream beds.

Early sluice boxes were wooden structures having a bottom lined with horizontal wooden planks known as riffles. When the sluice box is positioned in a river or stream, the riffles act like boulders in a stream to collect, behind them, the heavier material that is shoveled into the sluice box while allowing the lighter material to wash through the sluice box. In use, the prospector shovels material into the front of the sluice box for hours at a time. At the end of the day, he simply dumps the concentrate material that remains behind the riffles of the sluice box into a gold pan and then pans to recover the fine pieces of precious metal that were collected in the sluice box. Modern sluice boxes are constructed of lighter metal and plastic materials for ease of transport. They also employ angled metal riffles and miner moss or carpet material to aid in retaining the collected fine precious metal material.

Sluice boxes, used alone, have proven disadvantageous in that the prospector must manually feed material into them, whether by shoveling or dumping from a bucket, both of which methods are laborious. The prospector must also be careful not to overload the sluice box in order to prevent the valuable precious metal material from being washed directly through it.

In desert areas, there is rarely a nearby source of water sufficient to operate a sluice box or even to pan for gold. Wind erosion over the years has left many valuable deposits of precious metals lying on the surface. Old time prospectors developed what is called a dry washer to work these deposits. Dry washers are simply a set of bellows like those used years ago to fan fires. In use, dry washers are hand actuated beneath a set of riffles lying on a punch plate or a steel plate with holes punched in it. As the dirt is shoveled onto the plate, it is screened on a top section of the dry washer to remove the larger pieces of aggregate material. The remaining material passes across the riffles where the fanning action of the bellows blows the lighter material up and over the riffles and off the bottom end of the dry washer. The heavier gold pieces settle behind the riffles and are collected for later separation by panning in the presence of a water source. Modern dry washers employ gas blowers rather than bellows. In these dry washers, the riffle box is suspended on chains with a small fan having a weight attached to one side. The gas blower spins the fan that, in turn, vibrates the riffle box to further aid in moving the aggregate material along the length of the dry washer.

Gold dredges appeared in the early 1900s and were used to work the rivers for prospecting purposes. These early dredges utilized a large chain lined with buckets mounted on an extended arm. The arm was lowered into the river, and the buckets retrieved aggregate material from great depths. This material was then processed through a spinning trommel, a large cylinder having a multiplicity of approximately ½-inch holes on its peripheral surface. A spray bar within the trommel sprayed water on the collected material to wash dirt from the heavier material. Any of the material larger than the holes on the trammel surface washed out the rear end of the trommel, while the finer material dropped through the holes and was washed over a series of riffles that trapped the fine pieces of gold. Gold dredges were mounted on large barges which worked up and down rivers throughout the U.S. The large amounts of material moved by these dredges often resulted in changing the course of waterways being worked. The use of dredges declined over time, although some worked rivers in Alaska well into the 1980s.

A variation of the larger bucket dredge, known as the suction gold dredge, appeared in the late 1940s. This dredge utilized an engine-driven water pump and vacuum created by the flow of water. A hose on one end of the dredge vacuumed aggregate material from a river bed and deposited it at the front end of a set of riffles, which trapped any pieces of gold contained in the aggregate material as it washed over the set of riffles. These suction dredges were relatively portable and were fitted with tire tubes or pontoons for flotation. The machines allowed prospectors to efficiently remove gold from deep riverbeds. They were disadvantageous in that they required the use of dive gear such as wetsuits, goggles, and air systems to enable prospectors to descend into the cold and dark depths of a river in order to control the positioning of the underwater vacuum hose. In addition, the vacuum hoses were easily plugged by drawing in excessive amounts of aggregate material. A prospector can spend hours clearing obstructing material from a vacuum hose. In addition, these vacuum dredges are only able to work the beds of existing rivers because suction is lost when the intake end of the hose is removed from the water.

A prior art gold vacuum known as a vac-pac employs a vacuum source mounted atop a collection bucket and a suction hose coupled through a sidewall of the collection bucket. Air flows through the suction hose and exits the vacuum source, while dirt and other fine material, including precious metals, drop into the collection bucket. When full, the collection bucket must be carried by the prospector to a nearby sluice, high banker or dry washer, into which it is slowly dumped for separation of the fine precious metal material that has been collected. Carrying and emptying the collection bucket each time it fills becomes a time consuming and laborious task.

It would be advantageous to provide a self-emptying vacuum apparatus for use by gold prospectors that automatically periodically dumps fine material that has been suctioned from a surface area being worked.

In accordance with the illustrated preferred embodiment of the present invention, a self-emptying vacuum apparatus includes a collection chamber having a material discharge port at the bottom end thereof, a vacuum source having a vacuum input port and an exit port and being mounted atop the collection chamber such that the vacuum input port is in communication with the interior of the collection chamber, a suction hose coupled through the sidewall of the collection chamber near the top thereof, and a flapper assembly coupled beneath the material discharge port and including a hinged rubber flapper that automatically moves between open and closed positions. During operation, the vacuum source creates a vacuum within the collection chamber sufficient to draw the hinged rubber flapper to its closed position, thereafter causing vacuum air to flow into the collection chamber through the suction hose and through the output port to the outside environment. Fine material that is vacuumed into the suction hose from the surface being worked, including both dirt and flakes of precious metals, drops into the collection chamber. The vacuum source is arranged to generate a vacuum level sufficient to suction finer material through the suction hose, while excluding rocks. When the weight of the material accumulated in the collection chamber is sufficient to break the vacuum seal that maintains the hinged rubber flapper in its closed position, the hinged rubber flapper rotates downward to its open position, allowing the material in the collection chamber to fall by gravity onto a separation device, such as a conventional sluice box, for example, that is preferably positioned in a stream bed beneath the vacuum apparatus. As soon as each load of collected material is discharged, the hinged rubber flapper is again drawn by vacuum to its closed position, and the collection and discharge cycle is repeated. This automatic material collection and discharge cycle permits a prospector to continuously work a surface area with the suction hose, resulting in the ability to process more material in less time and with far less labor than is required when using prior art prospecting techniques.

### BRIEF DESCRIPTION OF THE DRAWINGS

FIG. 1 is an overall pictorial diagram of the vacuum apparatus for use in gold prospecting in accordance with the present invention, showing its typical positioning over a sluice box in a stream bed.

FIG. 2 is a cross-sectional diagram, taken along the section line 2-2 of FIG. 1, illustrating the interior of a flapper assembly that is coupled to a material discharge port of the vacuum apparatus, including a hinged rubber flapper shown in its closed position.

FIG. 3 is a cross-sectional diagram as in FIG. 2, illustrating the hinged rubber flapper in its open position that permits collected material to drop from the material discharge port through upper and lower openings in the flapper assembly and onto the sluice box below.

### DESCRIPTION OF THE PREFERRED EMBODIMENT

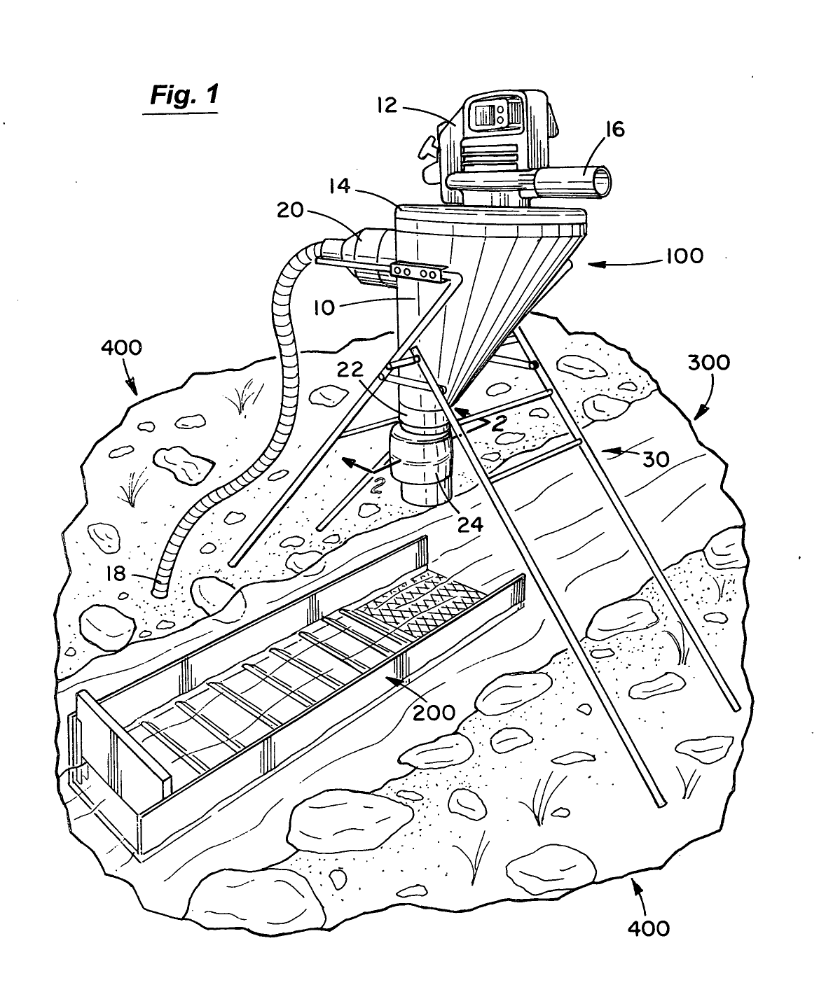

Referring now to FIG. 1, there is shown a vacuum apparatus 100 for use by gold prospectors positioned over a conventional sluice box 200 that is, in turn, preferably positioned in a stream bed 300 being worked or that is adjacent to a bank area 400 being worked. Vacuum apparatus 100 includes a collection chamber 10 that may be fabricated of a selected metal or plastic. A conventional vacuum source 12 is mounted to a cover 14 that forms the top of collection chamber 10. Vacuum source 12 is preferably powered by a gasoline motor and may constitute a conventional leaf blower/vacuum of the type commonly used by homeowners. Vacuum source 12 is positioned atop collection chamber 10 such that a vacuum input port thereof is in communication with the interior of collection chamber 10 by means of an air tight connection between the vacuum input port of vacuum source 12 and an opening in cover 14. For purposes of fabrication, assembly, and maintenance of collection chamber 10, cover 14 may be arranged to be removably connected to collection chamber 10. In that case, the connection interface is preferably caulked or otherwise sealed to prevent the escape of vacuum air. An exit port 16 of vacuum source 12 discharges air to the outside environment. A conventional suction hose 18 is attached to collection chamber 10 through an opening in a sidewall thereof that is proximate the top of collection chamber 10. Suction hose 18 is so attached by means of a coupler 20 to provide an air tight connection of suction hose 18 to collection chamber 10. Collection chamber 10 is preferably shaped to be downwardly tapered and to terminate in a discharge port 22.

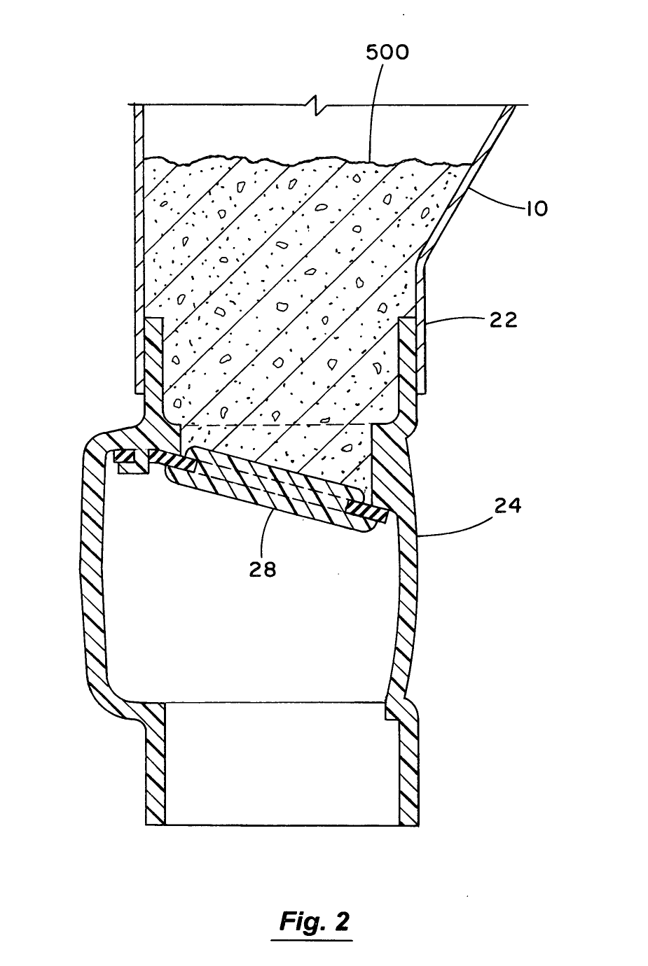

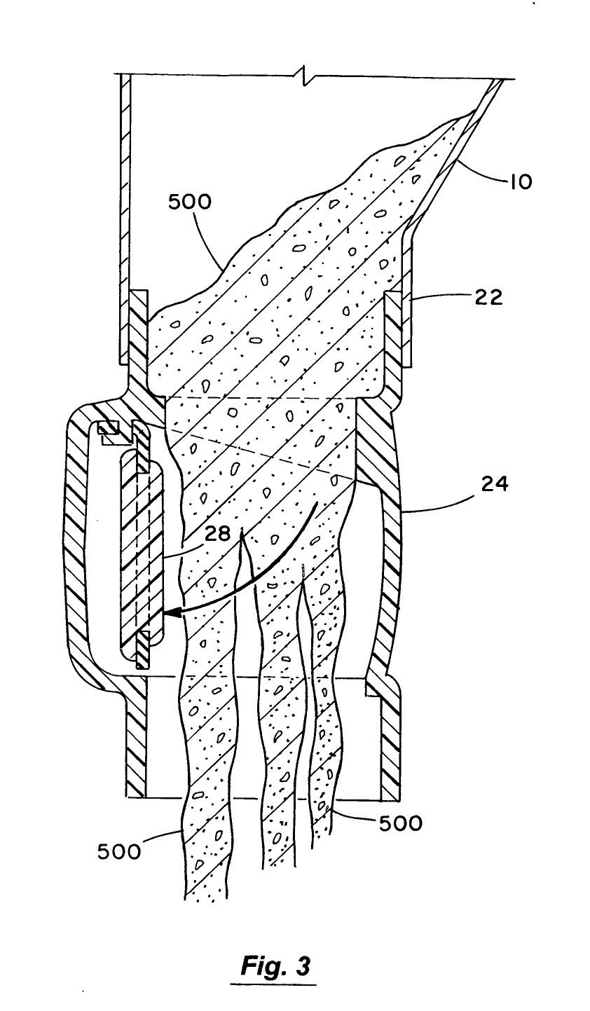

Referring now additionally to FIGS. 2 and 3, a depending flapper assembly 24 is attached to discharge port 22 in a conventional manner so as to provide an air tight connection therebetween. Flapper assembly 24 includes aligned upper and lower openings therein, through which material 500 in collection chamber 10 passes enroute to being deposited onto sluice box 200. Flapper assembly 24 may constitute a commercially available sump pump anti-siphon valve.

A rubber flapper 28 is hingedly attached within flapper assembly 24 so as to be movable between a generally horizontal or closed position, maintained by vacuum force against the upper opening in flapper assembly 24, as illustrated in FIG. 2, and a vertical or open position, as illustrated in FIG. 3, that clears a pathway between the upper and lower openings in flapper assembly 24.

A support structure 30 is arranged for removable attachment to collection chamber 10 to maintain vacuum apparatus 100 in a desired position and at an adjustable height over sluice box 200. Support structure 30 may take any of a number of conventional forms, but is preferably designed to be quickly assembled and disassembled in the field using a number of lightweight component parts that may be easily transported.

During operation of vacuum apparatus 100, vacuum source 12 creates a vacuum within collection chamber 10 sufficient to draw hinged rubber flapper 28 to its closed position illustrated in FIG. 2, thereafter causing vacuum air to flow into collection chamber 10 through suction hose 18 and out exit port 16 of vacuum source 12 to the outside environment. Material 500, including dirt and flakes of precious metals, that is vacuumed into suction hose 18 off the surface being worked, falls into collection chamber 10.

Vacuum source 12 is arranged to generate a vacuum level sufficient to suction finer material 500 through suction hose 18, while excluding rocks. When the weight of the material 500 collected and accumulated in collection chamber 10 is sufficient to overcome the vacuum force within collection chamber 10 that maintains hinged rubber flapper 28 in its closed position illustrated in FIG. 2, hinged rubber flapper 28 rotates downward approximately 90 degrees to its open position, allowing the collected material 500 accumulated in collection chamber 10 to drop by gravity onto sluice box 200. As soon as each load of accumulated material 500 is so discharged, hinged rubber flapper 28 is again drawn by vacuum within collection chamber 10 to its closed position, and another collection and discharge cycle is repeated.

I claim:

1. A self-emptying vacuum apparatus for use by gold prospectors to vacuum-collect material containing fine particles of gold and to automatically empty an accumulated quantity of the vacuum-collected material onto a separation device positioned beneath the vacuum apparatus, comprising:
a collection chamber having a side opening, a top opening, and a bottom discharge port, said collection chamber serving to accumulate a quantity of said vacuum-collected material;
a vacuum source mounted over said top opening of said collection chamber, said vacuum source having an input port that is positioned in communication with an interior volume of said collection chamber and having an exit port through which air is discharged to an outside environment;
a suction hose connected to said side opening of said collection chamber, said suction hose having a free end for manipulation by a prospector over a surface to be worked;
a flapper assembly connected to said discharge port of said collection chamber, said flapper assembly having generally aligned upper and lower openings through which said vacuum-collected material passes enroute to being discharged onto said separation device, said flapper assembly further comprising a flapper member hingedly attached within said flapper assembly, said flapper member being movable between a generally horizontal or closed position in which it is maintained against said upper opening in said flapper assembly by a vacuum force within said collection chamber to thereby cover said upper opening, and a generally vertical or open position that clears a pathway between said upper and lower openings in said flapper assembly, said flapper member moving from said closed position to said open position when the weight of said vacuum-collected material accumulated in said collection chamber is sufficient to overcome said vacuum force maintaining said flapper member in said closed position.

2. A self-emptying vacuum apparatus as in claim 1, wherein said collection chamber is formed to be downwardly tapered toward said discharge port.

3. A self-emptying vacuum apparatus as in claim 1, wherein said flapper member comprises a rubber flapper.

4. A self-emptying vacuum apparatus as in claim 1, further comprising an adjustable support structure removably attached to said collection chamber to maintain said vacuum apparatus in a desired position and at a desired height during operation.

5. A self-emptying vacuum apparatus as in claim 1, wherein said separation device comprises a sluice box.

6. A self-emptying vacuum apparatus as in claim 1, wherein:
a connection between said input port of said vacuum source and said top opening of said collection chamber comprises a generally air tight connection;
said connection of said suction hose to said side opening of said collection chamber comprises a generally air tight connection; and
said connection of said flapper assembly to said discharge port of said collection chamber comprises a generally air tight connection.

7. A self-emptying vacuum apparatus as in claim 1, wherein:
said collection chamber comprises a body member and a top cover member removably connected to said body member,
said top opening of said collection chamber comprises an opening in said top cover member; and
said connection of said top cover member to said body member comprises a generally air tight connection.
